(19) United States
(12) Patent Application Publication
(10) Pub. No.: US 2019/0065833 A1
(43) Pub. Date: Feb. 28, 2019

(54) DETECTING FALSE POSITIVES IN FACE RECOGNITION

(71) Applicant: QUALCOMM Incorporated, San Diego, CA (US)

(72) Inventors: Lei WANG, Clovis, CA (US); Ning BI, San Diego, CA (US); Ying CHEN, San Diego, CA (US)

(21) Appl. No.: 16/107,896

(22) Filed: Aug. 21, 2018

Related U.S. Application Data
(60) Provisional application No. 62/552,130, filed on Aug. 30, 2017.

(51) Int. Cl. G06K 9/00

(52) U.S. Cl. CPC G06K 9/00288; G06K 9/00744; G06K 9/00261; G06K 9/00281

(57) ABSTRACT

Techniques and systems are provided for detecting false positive faces in one or more video frames. For example, a video frame of a scene can be obtained. The video frame includes a face of a user associated with at least one characteristic feature. The face of the user is determined to match a representative face from stored representative data. The representative face is associated with the at least one characteristic feature. The face of the user is determined to match the representative face based on the at least one characteristic feature. The face of the user can then be determined to be a false positive face based on the face of the user matching the representative face.

### CROSS-REFERENCE TO RELATED APPLICATIONS

This application claims the benefit of U.S. Provisional Application No. 62/552,130, filed Aug. 30, 2017, which is hereby incorporated by reference, in its entirety and for all purposes.

### FIELD

The present disclosure generally relates to object recognition, and more specifically to techniques and systems for detecting false positives when performing object recognition to suppress false recognition of objects.

### BACKGROUND

Object recognition can be used to identify or verify an object from a digital image or a video frame of a video clip. One example of object recognition is face recognition, where a face of a person is detected and recognized. In some cases, the features of a face are extracted from an image and compared with features stored in a database in an attempt to recognize the face. In some cases, the extracted features are fed to a classifier and the classifier will give the identity of the input features. Object recognition is a time and resource intensive process. In some cases, false positive recognitions can be produced, in which case a face or other object is incorrectly recognized as belonging to a known face.

### BRIEF SUMMARY

In some examples, techniques and systems are described for detecting false positives in object recognition. An object can be detected as a false positive when the object is recognized based on a characteristic feature of the object. In some examples, an object can include a face of a person, and the characteristic feature can include a characteristic associated with the person's face. The characteristic feature of the face can include any unique feature that can cause a face recognition process to generate a match with an enrolled face, even when other features of the face are not similar to the enrolled face. For example, a characteristic feature of a face can include glasses (e.g., eyeglasses and/or sunglasses), facial hair (e.g., a beard, mustache, or other facial hair), a hat, or other characteristic feature associated with a face. The techniques and systems described herein can suppress the false recognition of different identities with similar characteristic features (e.g., different people having similar types of eyeglasses) by “trapping” the faces in images (that have the characteristic features) to pre-selected faces with similar characteristic features. For example, the techniques and systems can reduce the probability that a person in an image wearing eyeglasses will be recognized as a different person that is wearing similar eyeglasses.

In some implementations, data clustering can be used for detecting the false positives. For example, representative object features can be selected based on data clustering. In one illustrative example, given a face image training dataset that contains images with faces having the characteristic feature (e.g., faces wearing eyeglasses, faces with beards, or other feature), facial features can be extracted from each image. A facial feature can be represented as a feature vector generated using a feature extraction technique. These features can then be clustered into K data groups (or cluster groups) using a data clustering technique. The most similar faces to the cluster center will be selected as the face to represent the cluster. The features of these representative faces can be stored as representative data (e.g., the representative feature vectors of the faces) in a pre-defined database (also referred to herein as a secondary database).

The pre-defined database can be a pre-calculated database that is generated before run-time (before images are captured and analyzed for face recognition). At run-time, when an image with a face is fed into the face recognition system, the representative face features from the pre-defined database as well as face features from enrolled faces will be matched against the face in the image. The enrolled faces can include faces of users that are registered with the system. For example, feature vectors extracted from the enrolled faces can be stored in an enrolled database. In some cases, the enrolled database and the pre-defined database can be combined into a single database. If a face from an input image is determined to be most like a face from one of the representative faces of the pre-defined database, the face will be rejected as a false positive. Such a scenario (when a face is rejected due to matching a face from the pre-defined database) can be referred to as “face trap.”

The false positive detection techniques and systems can reduce the false positive rate and can improve the accuracy of the face recognition process as a whole. For instance, experimental results show that such techniques are useful in rejecting false positives due to matching a face with eyeglasses to an enrolled face with similar glasses.

According to at least one example, a method of detecting false positive faces in one or more video frames is provided. The method includes obtaining a video frame of a scene. The video frame includes a face of a user associated with at least one characteristic feature. The method further includes determining the face of the user matches a representative face from stored representative data. The representative face is associated with the at least one characteristic feature. The face of the user is determined to match the representative face based on the at least one characteristic feature. The method further includes determining the face of the user is a false positive face based on the face of the user matching the representative face.

In another example, an apparatus for detecting false positive faces in one or more video frames is provided that includes a memory configured to store video data and a processor. The processor is configured to and can obtain a video frame of a scene. The video frame includes a face of a user associated with at least one characteristic feature. The processor is configured to and can determine the face of the user matches a representative face from stored representative data. The representative face is associated with the at least one characteristic feature. The face of the user is determined to match the representative face based on the at least one characteristic feature. The processor is configured to and can determine the face of the user is a false positive face based on the face of the user matching the representative face.

In another example, a non-transitory computer-readable medium is provided that has stored thereon instructions that, when executed by one or more processors, cause the one or more processor to: obtain a video frame of a scene, the video frame including a face of a user associated with at least one characteristic feature; determine the face of the user matches a representative face from stored representative data, the representative face being associated with the at least one characteristic feature, wherein the face of the user is determined to match the representative face based on the at least one characteristic feature; and determine the face of the user is a false positive face based on the face of the user matching the representative face.

In another example, an apparatus for detecting false positive faces in one or more video frames is provided. The apparatus includes means for obtaining a video frame of a scene. The video frame includes a face of a user associated with at least one characteristic feature. The apparatus further includes means for determining the face of the user matches a representative face from stored representative data. The representative face is associated with the at least one characteristic feature. The face of the user is determined to match the representative face based on the at least one characteristic feature. The apparatus further includes means for determining the face of the user is a false positive face based on the face of the user matching the representative face.

In some aspects, the methods, apparatuses, and computer-readable medium described above further comprise: accessing the representative data, the representative data including information representing features of a plurality of representative faces associated with different versions of at least one characteristic feature; accessing registration data, the registration data including information representing features of a plurality of registered faces; and comparing information representing features of the face of the user with the information representing the features of the plurality of representative faces and with the information representing the features of the plurality of registered faces; wherein the face of the user is determined to match the representative face and determined be a false positive face based on the comparison. In some examples, comparing the information representing the features of the face of the user with the information representing the features of the plurality of registered faces is performed without using the at least one representative feature. In some examples, comparing the information representing the features of the face of the user with the information representing the features of the plurality of registered faces is performed using the at least one representative feature.

In some aspects, determining the face of the user matches the representative face from the representative data includes: comparing information representing features of the face of the user with information representing features of a plurality of representative faces from the representative data and with information representing features of a plurality of registered faces from registration data; and determining the face from the representative data is a closest match with the face of the user based on the comparison. In some aspects, the information representing features of the face of the user is determined by extracting features of the face from the video frame. In some aspects, the information representing the features of the plurality of faces from the representative data includes a plurality of representative feature vectors for the plurality of faces.

In some aspects, the at least one characteristic feature includes glasses, and wherein different versions of the at least one characteristic feature includes different types of glasses. In some aspects, the at least one characteristic feature includes facial hair, and wherein different versions of the at least one characteristic feature includes different types of facial hair. The characteristic feature can include any other suitable characteristic feature.

In some aspects, the methods, apparatuses, and computer-readable medium described above further comprise generating the representative data. Generating the representative data comprises: obtaining a set of representative images, each representative image including a face from a plurality of faces associated with different versions of the at least one characteristic feature; generating a plurality of feature vectors for the plurality of faces; clustering the plurality of feature vectors using data clustering to determine a plurality of cluster groups; determining, for a cluster group from the plurality of cluster groups, a representative feature vector from the plurality of feature vectors, the representative feature vector being closest to a mean of the cluster; and adding the representative feature vector to the representative data, the representative feature vector representing a representative face from a plurality of representative faces in the representative data.

In some aspects, the methods, apparatuses, and computer-readable medium described above further comprise: extracting one or more local features of each face from the plurality of faces; and generating the plurality of feature vectors for the plurality of faces using the extracted one or more local features.

In some aspects, the methods, apparatuses, and computer-readable medium described above further comprise: dividing the one or more local features into a plurality of feature groups; and wherein generating the plurality of feature vectors includes generating a feature vector for each feature group of the plurality of feature groups.

In some aspects, the apparatus comprises a mobile device. In some cases, the apparatus includes one or more of a camera for capturing the one or more video frames and a display for displaying the one or more video frames.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present invention are described in detail below with reference to the following drawing figures:

FIG. 1 is a block diagram illustrating an example of system for recognizing objects in one or more video frames, in accordance with some examples.

FIG. 2 is an example of an object recognition system, in accordance with some examples.

FIG. 3 is a diagram illustrating an example of an intersection and union of two bounding boxes, in accordance with some examples.

FIG. 4A is an example of a video frame showing detected objects within a scene being tracked, in accordance with some examples.

FIG. 4B is an example of a video frame showing detected objects within a scene being tracked, in accordance with some examples.

FIG. 5 is an example of a video frame showing a person within a scene wearing eyeglasses, in accordance with some examples.

FIG. 6 is an example of a video frame showing a person within a scene with a beard, in accordance with some examples.

FIG. 7 is a flowchart illustrating an example of a database initialization process, in accordance with some embodiments.

FIG. 8 is a flowchart illustrating an example of a false positive detection process that utilizes characteristic features to trap faces, in accordance with some embodiments.

FIG. 9 is an example of a chart illustrating a true positive rate when false positive detection is used versus when false positive detection is not used, in accordance with some embodiments.

FIG. 10 is an example of a chart illustrating a hit rate when false positive detection is used versus when false positive detection is not used, in accordance with some embodiments, in accordance with some embodiments.

FIG. 11 is a flowchart illustrating an example of a process of detecting false positive faces in one or more video frames, in accordance with some embodiments.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the invention. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

A video analytics system can obtain a sequence of video frames from a video source and can process the video sequence to perform a variety of tasks. One example of a video source can include an Internet protocol camera (IP camera) or other video capture device. An IP camera is a type of digital video camera that can be used for surveillance, home security, or other suitable application. Unlike analog closed circuit television (CCTV) cameras, an IP camera can send and receive data via a computer network and the Internet. In some instances, one or more IP cameras can be located in a scene or an environment, and can remain static while capturing video sequences of the scene or environment.

An IP camera can be used to send and receive data via a computer network and the Internet. In some cases, IP camera systems can be used for two-way communications. For example, data (e.g., audio, video, metadata, or the like) can be transmitted by an IP camera using one or more network cables or using a wireless network, allowing users to communicate with what they are seeing. In one illustrative example, a gas station clerk can assist a customer with how to use a pay pump using video data provided from an IP camera (e.g., by viewing the customer's actions at the pay pump). Commands can also be transmitted for pan, tilt, zoom (PTZ) cameras via a single network or multiple networks. Furthermore, IP camera systems provide flexibility and wireless capabilities. For example, IP cameras provide for easy connection to a network, adjustable camera location, and remote accessibility to the service over Internet. IP camera systems also provide for distributed intelligence. For example, with IP cameras, video analytics can be placed in the camera itself. Encryption and authentication is also easily provided with IP cameras. For instance, IP cameras offer secure data transmission through already defined encryption and authentication methods for IP based applications. Even further, labor cost efficiency is increased with IP cameras. For example, video analytics can produce alarms for certain events, which reduces the labor cost in monitoring all cameras (based on the alarms) in a system.

Video analytics provides a variety of tasks ranging from immediate detection of events of interest, to analysis of pre-recorded video for the purpose of extracting events in a long period of time, as well as many other tasks. Various research studies and real-life experiences indicate that in a surveillance system, for example, a human operator typically cannot remain alert and attentive for more than 20 minutes, even when monitoring the pictures from one camera. When there are two or more cameras to monitor or as time goes beyond a certain period of time (e.g., 20 minutes), the operator's ability to monitor the video and effectively respond to events is significantly compromised. Video analytics can automatically analyze the video sequences from the cameras and send alarms for events of interest. This way, the human operator can monitor one or more scenes in a passive mode. Furthermore, video analytics can analyze a huge volume of recorded video and can extract specific video segments containing an event of interest.

Video analytics also provides various other features. For example, video analytics can operate as an Intelligent Video Motion Detector by detecting moving objects and by tracking moving objects. In some cases, the video analytics can generate and display a bounding box around a valid object. Video analytics can also act as an intrusion detector, a video counter (e.g., by counting people, objects, vehicles, or the like), a camera tamper detector, an object left detector, an object/asset removal detector, an asset protector, a loitering detector, and/or as a slip and fall detector. Video analytics can further be used to perform various types of recognition functions, such as face detection and recognition, license plate recognition, object recognition (e.g., bags, logos, body marks, or the like), or other recognition functions. In some cases, video analytics can be trained to recognize certain objects. Another function that can be performed by video analytics includes providing demographics for customer metrics (e.g., customer counts, gender, age, amount of time spent, and other suitable metrics). Video analytics can also perform video search (e.g., extracting basic activity for a given region) and video summary (e.g., extraction of the key movements). In some instances, event detection can be performed by video analytics, including detection of fire, smoke, fighting, crowd formation, or any other suitable even the video analytics is programmed to or learns to detect. A detector can trigger the detection of an event of interest and can send an alert or alarm to a central control room to alert a user of the event of interest.

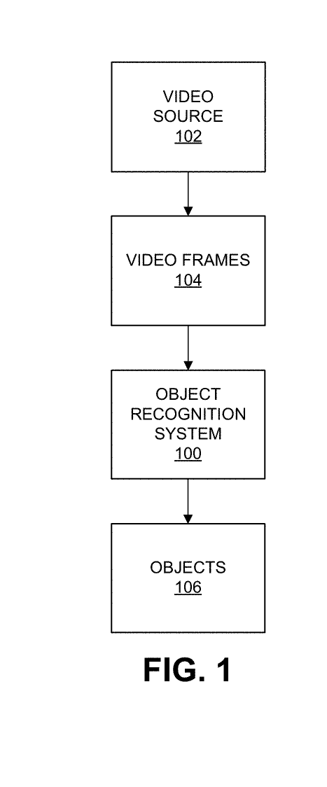

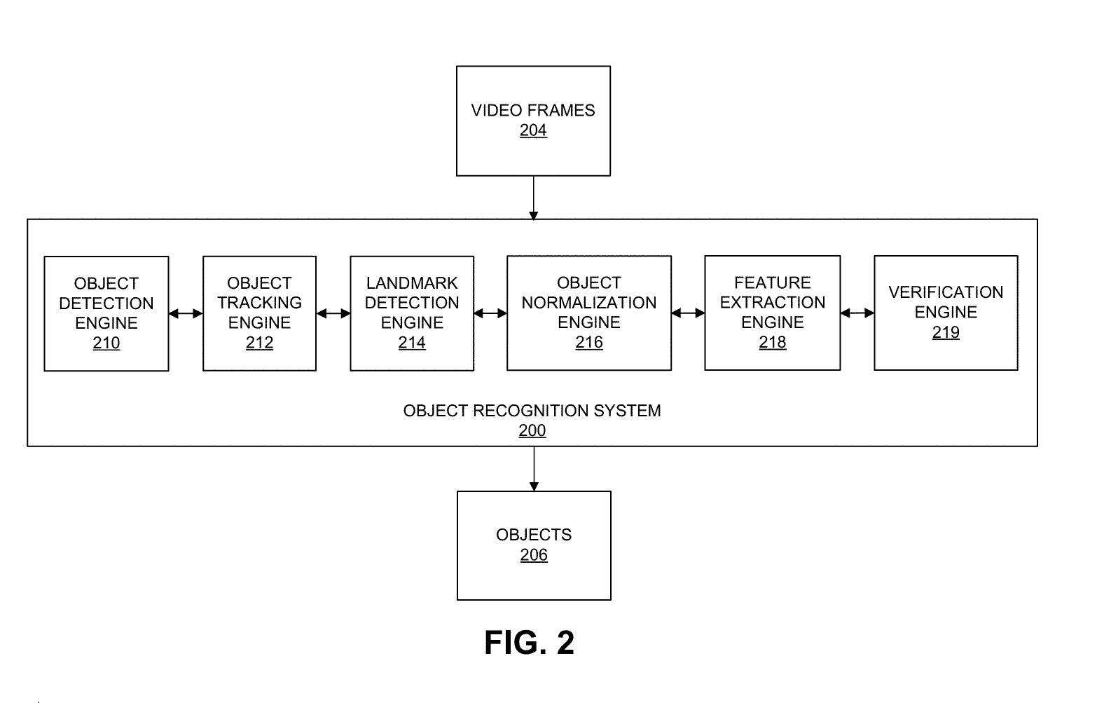

As described in more detail herein, an object recognition system can detect, track, and, in some cases, recognize objects in one or more video frames that capture images of a scene. Some objects can be rejected if the object is recognized based on a characteristic feature of the object. For example, an object can include a face of a person, and the characteristic feature can include characteristics associated with the person's face, such as eyeglasses, facial hair, a hat, or other feature that can cause the face to be falsely recognized as an enrolled face. Details of an example object recognition system are described below with respect to FIG. 1 and FIG. 2.

FIG. 1 is a block diagram illustrating an example of a system for recognizing objects in one or more video frames. The object recognition system 100 receives video frames 104 from a video source 102. The video frames 104 can also be referred to herein as video pictures or pictures. The video frames 104 capture or contain images of a scene, and can be part of one or more video sequences. The video source 102 can include a video capture device (e.g., a video camera, a camera phone, a video phone, or other suitable capture device), a video storage device, a video archive containing stored video, a video server or content provider providing video data, a video feed interface receiving video from a video server or content provider, a computer graphics system for generating computer graphics video data, a combination of such sources, or other source of video content. In one example, the video source 102 can include an IP camera or multiple IP cameras. In an illustrative example, multiple IP cameras can be located throughout a scene or environment, and can provide the video frames 104 to the object recognition system 100. For instance, the IP cameras can be placed at various fields of view within the scene so that surveillance can be performed based on the captured video frames 104 of the scene. The object detection techniques described herein can also be performed on images other than those captured by video frames, such as still images captured by a camera or other suitable images.

In some embodiments, the object recognition system 100 and the video source 102 can be part of the same computing device. In some embodiments, the object recognition system 100 and the video source 102 can be part of separate computing devices. In some examples, the computing device (or devices) can include one or more wireless transceivers for wireless communications. The computing device (or devices) can include an electronic device, such as a camera (e.g., an IP camera or other video camera, a camera phone, a video phone, or other suitable capture device), a mobile or stationary telephone handset (e.g., smartphone, cellular telephone, or the like), a desktop computer, a laptop or notebook computer, a tablet computer, a set-top box, a television, a display device, a digital media player, a video gaming console, a video streaming device, or any other suitable electronic device.

The object recognition system 100 processes the video frames 104 to detect and track objects in the video frames 104. In some cases, the objects can also be recognized by comparing features of the detected and/or tracked objects with enrolled objects that are registered with the object recognition system 100. The object recognition system 100 outputs objects 106 as detected and tracked objects and/or as recognized objects.

Any type of object recognition can be performed by the object recognition system 100. An example of object recognition includes face recognition, where faces of people in a scene captured by video frames are analyzed and detected, tracked, and/or recognized using the techniques described herein. An example face recognition process identifies and/or verifies an identity of a person from a digital image or a video frame of a video clip. In some cases, the features of the face are extracted from the image and compared with features of known faces stored in a database (e.g., an enrolled database). In some cases, the extracted features are fed to a classifier and the classifier can give the identity of the input features. One illustrative example of a method for recognizing a face includes performing face detection, face tracking, facial landmark detection, face normalization, feature extraction, and face identification and/or face verification. Face detection is a kind of object detection and the only object to be detected is face. While techniques are described herein using face recognition as an illustrative example of object recognition, one of ordinary skill will appreciate that the same techniques can apply to recognition of other types of objects.

FIG. 2 is a block diagram illustrating an example of an object recognition system 200. The object recognition system 200 processes video frames 204 and outputs objects 206 as detected, tracked, and/or recognized objects. The object recognition system 200 can perform any type of object recognition. An example of object recognition performed by the object recognition system 200 includes face recognition. However, one of ordinary skill will appreciate that any other suitable type of object recognition can be performed by the object recognition system 200. One example of a full face recognition process for recognizing objects in the video frames 204 includes the following steps: object detection; object tracking; object landmark detection; object normalization; feature extraction; and identification and/or verification. Object recognition can be performed using some or all of these steps, with some steps being optional in some cases.

The object recognition system 200 includes an object detection engine 210 that can perform object detection. In one illustrative example, the object detection engine 210 can perform face detection to detect one or more faces in a video frame. Object detection is a technology to identify objects from an image or video frame. For example, face detection can be used to identify faces from an image or video frame. Many object detection algorithms (including face detection algorithms) use template matching techniques to locate objects (e.g., faces) from the images. Various types of template matching algorithms can be used. In other object detection algorithm can also be used by the object detection engine 210.

One example template matching algorithm contains four steps, including Haar feature extraction, integral image generation, Adaboost training, and cascaded classifiers. Such an object detection technique performs detection by applying a sliding window across a frame or image. For each current window, the Haar features of the current window are computed from an Integral image, which is computed beforehand. The Haar features are selected by an Adaboost algorithm and can be used to classify a window as a face (or other object) window or a non-face window effectively with a cascaded classifier. The cascaded classifier includes many classifiers combined in a cascade, which allows background regions of the image to be quickly discarded while spending more computation on object-like regions. For example, the cascaded classifier can classify a current window into a face category or a non-face category. If one classifier classifies a window as a non-face category, the window is discarded. Otherwise, if one classifier classifies a window as a face category, a next classifier in the cascaded arrangement will be used to test again. Until all the classifiers determine the current window is a face, the window will be labeled as a candidate of face. After all the windows are detected, a non-max suppression algorithm is used to group the face windows around each face to generate the final result of detected faces. Further details of such an object detection algorithm is described in P. Viola and M. Jones, “Robust real time object detection,” IEEE ICCV Workshop on Statistical and Computational Theories of Vision, 2001, which is hereby incorporated by reference, in its entirety and for all purposes.

Other suitable object detection techniques could also be performed by the object detection engine 210. One illustrative example of object detection includes an example-based learning for view-based face detection, such as that described in K. Sung and T. Poggio, “Example-based learning for view-based face detection,” IEEE Patt. Anal. Mach. Intell., volume 20, pages 39-51, 1998, which is hereby incorporated by reference, in its entirety and for all purposes. Another example is neural network-based object detection, such as that described in H. Rowley, S. Baluja, and T. Kanade, “Neural network-based face detection,” IEEE Patt. Anal. Mach. Intell., volume 20, pages 22-38, 1998., which is hereby incorporated by reference, in its entirety and for all purposes. Yet another example is statistical-based object detection, such as that described in H. Schneiderman and T. Kanade, “A statistical method for 3D object detection applied to faces and cars,” International Conference on Computer Vision, 2000, which is hereby incorporated by reference, in its entirety and for all purposes. Another example is a snowbased object detector, such as that described in D. Roth, M. Yang, and N. Ahuja, “A snowbased face detector,” Neural Information Processing 12, 2000, which is hereby incorporated by reference, in its entirety and for all purposes. Another example is a joint induction object detection technique, such as that described in Y. Amit, D. Geman, and K. Wilder, “Joint induction of shape features and tree classifiers,” 1997, which is hereby incorporated by reference, in its entirety and for all purposes. Any other suitable image-based object detection technique can be used.

The object recognition system 200 further includes an object tracking engine 212 that can perform object tracking for one or more of the objects detected by the object detection engine 210. In one illustrative example, the object detection engine 212 can track faces detected by the object detection engine 210. Object tracking includes tracking objects across multiple frames of a video sequence or a sequence of images. For instance, face tracking is performed to track faces across frames or images. The full object recognition process (e.g., a full face recognition process) is time consuming and resource intensive, and thus it is sometimes not realistic to recognize all objects (e.g., faces) for every frame, such as when numerous faces are captured in a current frame. In order to reduce the time and resources needed for object recognition, object tracking techniques can be used to track previously recognized faces. For example, if a face has been recognized and the object recognition system 200 is confident of the recognition results (e.g., a high confidence score is determined for the recognized face), the object recognition system 200 can skip the full recognition process for the face in one or several subsequent frames if the face can be tracked successfully by the object tracking engine 212.

Any suitable object tracking technique can be used by the object tracking engine 212. One example of a face tracking technique includes a key point technique. The key point technique includes detecting some key points from a detected face (or other object) in a previous frame. For example, the detected key points can include significant corners on face, such as facial landmarks (described in more detail below). The key points can be matched with features of objects in a current frame using template matching. As used herein, a current frame refers to a frame currently being processed. Examples of template matching methods can include optical flow, local feature matching, and/or other suitable techniques. In some cases, the local features can be histogram of gradient, local binary pattern (LBP), or other features. Based on the tracking results of the key points between the previous frame and the current frame, the faces in the current frame that match faces from a previous frame can be located.

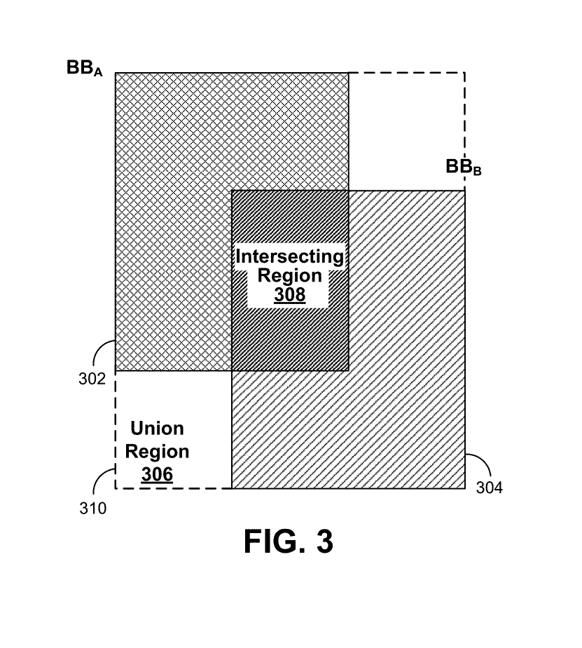

Another example object tracking technique is based on the face detection results. For example, the intersection over union (IOU) of face bounding boxes can be used to determine if a face detected in the current frame matches a face detected in the previous frame. FIG. 3 is a diagram showing an example of an intersection I and union U of two bounding boxes, including bounding box BB_{A} 302 of an object in a current frame and bounding box BB_{B} 304 of an object in the previous frame. The intersecting region 308 includes the overlapped region between the bounding box BB_{A} 302 and the bounding box BB_{B} 304.

The union region 306 includes the union of bounding box BB_{A} 302 and bounding box BB_{B} 304. The union of bounding box BB_{A} 302 and bounding box BB_{B} 304 is defined to use the far corners of the two bounding boxes to create a new bounding box 310 (shown as dotted line). More specifically, by representing each bounding box with (x, y, w, h), where (x, y) is the upper-left coordinate of a bounding box, w and h are the width and height of the bounding box, respectively, the union of the bounding boxes would be represented as follows:

Union(BB₁,BB₂)=(min(x₁,x₂),min(y₁,y₂),(max(x₁+w₁−1,x₂+w₂−1)−min(x₁,x₂)),(max(y₁+h₁−1,y₂+h₂−1)−min(y₁,y₂)))

Using FIG. 3 as an example, the first bounding box 302 and the second bounding box 304 can be determined to match for tracking purposes if an overlapping area between the first bounding box 302 and the second bounding box 304 (the intersecting region 308) divided by the union 310 of the bounding boxes 302 and 304 is greater than an IOU threshold (denoted as

$${T}_{IOU} < \frac{Area of Intersecting Region 308}{Area of Union 310} ) .$$

The IOU threshold can be set to any suitable amount, such as 50%, 60%, 70%, 75%, 80%, 90%, or other configurable amount. In one illustrative example, the first bounding box 302 and the second bounding box 304 can be determined to be a match when the IOU for the bounding boxes is at least 70%. The object in the current frame can be determined to be the same object from the previous frame based on the bounding boxes of the two objects being determined as a match.

In another example, an overlapping area technique can be used to determine a match between bounding boxes. For instance, the first bounding box 302 and the second bounding box 304 can be determined to be a match if an area of the first bounding box 302 and/or an area the second bounding box 304 that is within the intersecting region 308 is greater than an overlapping threshold. The overlapping threshold can be set to any suitable amount, such as 50%, 60%, 70%, or other configurable amount. In one illustrative example, the first bounding box 302 and the second bounding box 304 can be determined to be a match when at least 65% of the bounding box 302 or the bounding box 304 is within the intersecting region 308.

In some implementations, the key point technique and the IOU technique (or the overlapping area technique) can be combined to achieve even more robust tracking results. Any other suitable object tracking (e.g., face tracking) techniques can be used. Using any suitable technique, face tracking can reduce the face recognition time significantly, which in turn can save CPU bandwidth and power.

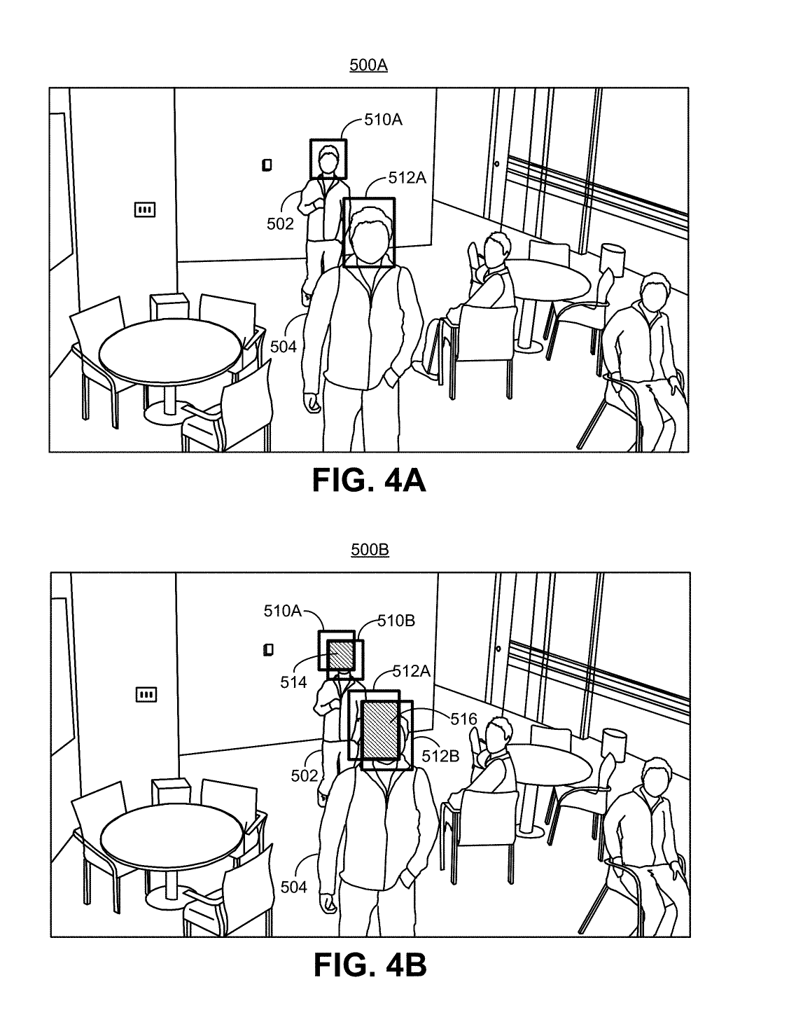

An illustrative example of face tracking is illustrated in FIG. 4A and FIG. 4B. As noted above, a face is tracked over a sequence of video frames based on face detection. For instance, the object tracking engine 212 can compare a bounding box of a face detected in a current frame against all the faces detected in the previous frame to determine similarities between the detected face and the previously detected faces. The previously detected face that is determined to be the best match is then selected as the face that will be tracked based on the currently detected face. In some cases, the face detected in the current frame can be assigned the same unique identifier as that assigned to the previously detected face in the previous frame.

The video frames 400A and 400B shown in FIG. 4A and FIG. 4B illustrate two frames of a video sequence capturing images of a scene. The multiple faces in the scene captured by the video sequence can be detected and tracked across the frames of the video sequence, including frames 400A and 400B. The frame 400A can be referred to as a previous frame and the frame 400B can be referred to as a current frame.

As shown in FIG. 4A, the face of the person 402 is detected from the frame 400A and the location of the face is represented by the bounding box 410A. The face of the person 404 is detected from the frame 400A and the location of the face is represented by the bounding box 412A. As shown in FIG. 4B, the face of the person 402 is detected from the frame 400B and the location of the face is represented by the bounding box 410B. Similarly, the face of the person 404 is detected from the frame 400B and its location is represented by the bounding box 412B. The object detection techniques described above can be used to detect the faces.

The persons 402 and 404 are tracked across the video frames 400A and 400B by assigning a unique tracking identifier to each of the bounding boxes. A bounding box in the current frame 400B that matches a previous bounding box from the previous frame 400A can be assigned the unique tracking identifier that was assigned to the previous bounding box. In this way, the face represented by the bounding boxes can be tracked across the frames of the video sequence. For example, as shown in FIG. 4B, the current bounding box 410B in the current frame 400B is matched to the previous bounding box 410A from the previous frame 400A based on a spatial relationship between the two bounding boxes 410A and 410B or based on features of the faces. In one illustrative example, as described above, an intersection over union (IOU) approach can be used, in which case the current bounding box 410B and the previous bounding box 410A can be determined to match if the intersecting region 414 (also called an overlapping area) divided by a union of the bounding boxes 410A and 410B is greater than an IOU threshold. The IOU threshold can be set to any suitable amount, such as 70% or other configurable amount. In another example, an overlapping area technique can be used, in which case the current bounding box 410B and the previous bounding box 410A can be determined to be a match if at least a threshold amount of the area of the bounding box 410B and/or the area the bounding box 410A is within the intersecting region 414. The overlapping threshold can be set to any suitable amount, such as 70% or other configurable amount. In some cases, the key point technique described above could also be used, in which case key points are matched with features of the faces in the current frame using template matching. Similar techniques can be used to match the current bounding box 412B with the previous bounding box 412A (e.g., based on the intersecting region 416, based on key points, or the like).

The landmark detection engine 214 can perform object landmark detection. For example, the landmark detection engine 214 can perform facial landmark detection for face recognition. Facial landmark detection can be an important step in face recognition. For instance, object landmark detection can provide information for object tracking (as described above) and can also provide information for face normalization (as described below). A good landmark detection algorithm can improve the face recognition accuracy significantly, as well as the accuracy of other object recognition processes.

One illustrative example of landmark detection is based on a cascade of regressors method. Using such a method in face recognition, for example, a cascade of regressors can be learned from faces with labeled landmarks. A combination of the outputs from the cascade of the regressors provides accurate estimation of landmark locations. The local distribution of features around each landmark can be learned and the regressors will give the most probable displacement of the landmark from the previous regressor's estimate. Further details of a cascade of regressors method is described in V. Kazemi and S. Josephine, “One millisecond face alignment with an ensemble of regression trees,” CVPR, 2014, which is hereby incorporated by reference, in its entirety and for all purposes. Any other suitable landmark detection techniques can also be used by the landmark detection engine 214.

The object recognition system 200 further includes an object normalization engine 216 for performing object normalization. Object normalization can be performed to align objects for better object recognition results. For example, the object normalization engine 216 can perform face normalization by processing an image to align and/or scale the faces in the image for better recognition results. One example of a face normalization method uses two eye centers as reference points for normalizing faces. The face image can be translated, rotated, and scaled to ensure the two eye centers are located at the designated location with a same size. A similarity transform can be used for this purpose. Another example of a face normalization method can use five points as reference points, including two centers of the eyes, two corners of the mouth, and a nose tip. In some cases, the landmarks used for reference points can be determined from facial landmark detection.

In some cases, the illumination of the face images may also need to be normalized. One example of an illumination normalization method is local image normalization. With a sliding window be applied to an image, each image patch is normalized with its mean and standard deviation. The center pixel value is subtracted from the mean of the local patch and then divided by the standard deviation of the local patch. Another example method for lighting compensation is based on discrete cosine transform (DCT). For instance, the second coefficient of the DCT can represent the change from a first half signal to the next half signal with a cosine signal. This information can be used to compensate a lighting difference caused by side light, which can cause part of a face (e.g., half of the face) to be brighter than the remaining part (e.g., the other half) of the face. The second coefficient of the DCT transform can be removed and an inverse DCT can be applied to get the left-right lighting normalization.

The feature extraction engine 218 performs feature extraction, which is an important part of the object recognition process. An example of a feature extraction process is based on steerable filters. A steerable filter-based feature extraction approach operates to synthesize filters using a set of basis filters. For instance, the approach provides an efficient architecture to synthesize filters of arbitrary orientations using linear combinations of basis filters. Such a process provides the ability to adaptively steer a filter to any orientation, and to determine analytically the filter output as a function of orientation. In one illustrative example, a two-dimensional (2D) simplified circular symmetric Gaussian filter can be represented as:

G(x,y)=e^{-(x}^{²}^{+y}^{²}⁾,

where x and y are Cartesian coordinates, which can represent any point, such as a pixel of an image or video frame. The n-th derivative of the Gaussian is denoted as Gₙ, and the notation ( . . . )^{θ} represents the rotation operator. For example, ƒ^{θ}(x, y) is the function ƒ(x, y) rotated through an angle θ about the origin. The x derivative of G(x,y) is:

$${G}_{1}^{0 °} = \frac{\partial }{\partial x} G ( x , y ) = - 2 {xe}^{- ( {x}^{2} + {y}^{2} )} ,$$

and the same function rotated 90° is:

$${G}_{1}^{90 °} = \frac{\partial }{\partial y} G ( x , y ) = - 2 {ye}^{- ( {x}^{2} + {y}^{2} )} ,$$

where G₁^{0°} and G₁^{90°} are called basis filters since G₁^{θ} can be represented as G₁^{θ}=cos(θ)G₁^{0°} +sin(θ)G₁^{90°} and θ is arbitrary angle, indicating that G₁^{0°} and G₁^{90°} span the set of G₁^{θ} filters (hence, basis filters). Therefore, G₁^{0°} and G₁^{90°} can be used to synthesize filters with any angle. The cos(θ) and sin(θ) terms are the corresponding interpolation functions for the basis filters.

Steerable filters can be convolved with face images to produce orientation maps which in turn can be used to generate features (represented by feature vectors). For instance, because convolution is a linear operation, the feature extraction engine 218 can synthesize an image filtered at an arbitrary orientation by taking linear combinations of the images filtered with the basis filters G₁^{0°} and G₁^{90°}. In some cases, the features can be from local patches around selected locations on detected faces (or other objects). Steerable features from multiple scales and orientations can be concatenated to form an augmented feature vector that represents a face image (or other object). For example, the orientation maps from G₁^{0°} and G₁^{90°} can be combined to get one set of local features, and the orientation maps from G₁^{45°} and G₁^{135°} can be combined to get another set of local features. In one illustrative example, the feature extraction engine 218 can apply one or more low pass filters to the orientation maps, and can use energy, difference, and/or contrast between orientation maps to obtain a local patch. A local patch can be a pixel level element. For example, an output of the orientation map processing can include a texture template or local feature map of the local patch of the face being processed. The resulting local feature maps can be concatenated to form a feature vector for the face image. Further details of using steerable filters for feature extraction are described in William T. Freeman and Edward H. Adelson, “The design and use of steerable filters,” IEEE Transactions on Pattern Analysis and Machine Intelligence, 13(9):891-906, 1991, and in Mathews Jacob and Michael Unser, “Design of Steerable Filters for Feature Detection Using Canny-Like Criteria,” IEEE Transactions on Pattern Analysis and Machine Intelligence, 26(8):1007-1019, 2004, which are hereby incorporated by reference, in their entirety and for all purposes.

Postprocessing on the feature maps such as LDA/PCA can also be used to reduce the dimensionality of the feature size. In order to compensate the errors in landmark detection, a multiple scale feature extraction can be used to make the features more robust for matching and/or classification.

The verification engine 219 performs object identification and/or object verification. Face identification and verification is one example of object identification and verification. For example, face identification is the process to identify which person identifier a detected and/or tracked face should be associated with, and face verification is the process to verify if the face belongs to the person to which the face is claimed to belong. The same idea also applies to objects in general, where object identification identifies which object identifier a detected and/or tracked object should be associated with, and object verification verifies if the detected/tracked object actually belongs to the object with which the object identifier is assigned. Objects can be enrolled or registered in an enrolled database that contains known objects. For example, an owner of a camera containing the object recognition system 200 can register the owner's face and faces of other trusted users. The enrolled database can be located in the same device as the object recognition system 200, or can be located remotely (e.g., at a remote server that is in communication with the system 200). The database can be used as a reference point for performing object identification and/or object verification. In one illustrative example, object identification and/or verification can be used to authenticate a user to the camera and/or to indicate an intruder or stranger has entered a scene monitored by the camera.

Object identification and object verification present two related problems and have subtle differences. Object identification can be defined as a one-to-multiple problem in some cases. For example, face identification (as an example of object identification) can be used to find a person from multiple persons. Face identification has many applications, such as for performing a criminal search. Object verification can be defined as a one-to-one problem. For example, face verification (as an example of object verification) can be used to check if a person is who they claim to be (e.g., to check if the person claimed is the person in an enrolled database). Face verification has many applications, such as for performing access control to a device, system, or other accessible item.

Using face identification as an illustrative example of object identification, an enrolled database containing the features of enrolled faces can be used for comparison with the features of one or more given query face images (e.g., from input images or frames). The enrolled faces can include faces registered with the system and stored in the enrolled database, which contains known faces. A most similar enrolled face can be determined to be a match with a query face image. The person identifier of the matched enrolled face (the most similar face) is identified as the person to be recognized. In some implementations, similarity between features of an enrolled face and features of a query face can be measured with distance. Any suitable distance can be used, including Cosine distance, Euclidean distance, Manhattan distance, Mahalanobis distance, or other suitable distance. One method to measure similarity is to use matching scores. A matching score represents the similarity between features, where a very high score between two feature vectors indicates that the two feature vectors are very similar. A feature vector for a face can be generated using feature extraction, as described above. In one illustrative example, a similarity between two faces (represented by a face patch) can be computed as the sum of similarities of the two face patches. The sum of similarities can be based on a Sum of Absolute Differences (SAD) between the probe patch feature (in an input image) and the gallery patch feature (stored in the database). In some cases, the distance is normalized to 0 and 1. As one example, the matching score can be defined as 1000*(1-distance).

Another illustrative method for face identification includes applying classification methods, such as a support vector machine to train a classifier that can classify different faces using given enrolled face images and other training face images. For example, the query face features can be fed into the classifier and the output of the classifier will be the person identifier of the face.

For face verification, a provided face image will be compared with the enrolled faces. This can be done with simple metric distance comparison or classifier trained with enrolled faces of the person. In general, face verification needs higher recognition accuracy since it is often related to access control. A false positive is not expected in this case. For face verification, a purpose is to recognize who the person is with high accuracy but with low rejection rate. Rejection rate is the percentage of faces that are not recognized due to the matching score or classification result being below the threshold for recognition.

Metrics can be defined for measuring the performance of object recognition results. For example, in order to measure the performance of face recognition algorithms, it is necessary certain metrics can be defined. Face recognition can be considered as a kind of classification problem. True positive rate and false positive rate can be used to measure the performance. One example is a receiver operating characteristic (ROC). The ROC curve is created by plotting the true positive rate (TPR) against the false positive rate (FPR) at various threshold settings. In a face recognition scenario, true positive rate is defined as the percentage that a person is correctly identified as himself/herself and false positive rate is defined as the percentage that a person is wrongly classified as another person. However, both face identification and verification should use a confidence threshold to determine if the recognition result is valid. In some cases, all faces that are determined to be similar to and thus match one or more enrolled faces are given a confidence score. Determined matches with confidence scores that are less than a confidence threshold will be rejected. In some cases, the percentage calculation will not consider the number of faces that are rejected to be recognized due to low confidence. In such cases, a rejection rate should also be considered as another metric, in addition to true positive and false positive rates.

Several problems can arise due to object recognition. For example, in some cases, some faces are enrolled in an enrolled database with certain characteristic features and some other faces are enrolled that do not include characteristic features. A characteristic feature for a face can include eyeglasses, facial hair, a hat, or other feature that can cause the face to be falsely recognized as an enrolled face. Other types of objects can also have characteristic features, such as features having strong edge information (as explained below). The characteristic features can cause a false positive recognition to occur. For example, a first person in an input image that has a face with a similar characteristic feature as that of an enrolled face (e.g., a second person wearing eyeglasses or other feature) can be recognized as the second person the enrolled face belongs to, due to the enrolled face having the similar characteristic feature (e.g., having similar glasses or other similar feature) as the face of the first person. The first person in the input image would not be recognized as the enrolled person if the enrolled person's face was enrolled without the characteristic feature (e.g., eyeglasses or other feature). One of the reasons such a situation occurs is that certain characteristic features (e.g., eyeglasses, facial hair, a hat, or other features) contain strong edge information after filtering is performed. For example, eyeglasses containing strong edge information after filtering and the energy from the eyeglasses is stronger than those from facial features since the eyeglasses cover a large portion of the face. Such a situation presents a challenging problem in face recognition.

Systems and methods are described herein for reducing the probability that an object having certain characteristic features will be recognized as another object having similar characteristic features. Examples of the systems and methods will be described herein using faces as an example of objects. However, one of ordinary skill will appreciate that the methods and systems can be applied for performing recognition of any type of object. For example, when performing face recognition (or any other type of object recognition), the methods can reduce the possibility that a person wearing eyeglasses will be recognized as another person wearing similar glasses. In some examples, the methods can be based on data clustering. For instance, representative object features can be selected based on data clustering. In one illustrative example, given a face image dataset that contains images with multiple faces having one or more characteristic features (e.g., faces wearing eyeglasses, faces with beards, or other feature), the facial features of the multiple faces can be extracted from the images. A facial feature can be represented as a feature vector generated using a feature extraction technique. These features of the multiple faces can be clustered into K data groups (also referred to as clusters or cluster groups) using a data clustering technique. The most similar faces to the cluster center can then be selected as the representative face to represent the cluster. The features of these representative faces can be stored as representative data in a pre-defined database. The pre-defined database can be a pre-calculated database that is generated before run-time (before images are captured and analyzed for face recognition). For example, the pre-defined database can be pre-programmed and stored in a device (e.g., an IP camera, another type of camera, a mobile phone, or other suitable device) before the device is used to capture images and perform face recognition.

An enrolled database that stores data representing enrolled faces can also be maintained. The enrolled faces can include faces of users that are registered with the system. In some cases, facial features of the enrolled faces can be stored in an enrolled database as one or more feature vectors. At run-time, when images are captured and faces from the captured images are fed into the face recognition system, the facial features of the faces in the captured images will be matched against the facial features from the pre-defined database and also against the facial features of the enrolled faces from the enrolled database. If a face is determined be most like a face from one of the representative faces of the pre-defined database, the face will be rejected as a false positive (referred to as face trap or false positive detection). However, if a face is determined be most like a face from one of the enrolled faces, the face will be recognized as the matched face. Using such systems and methods, the false positive rate of a face recognition system and the accuracy of the face recognition process as a whole can be greatly improved.

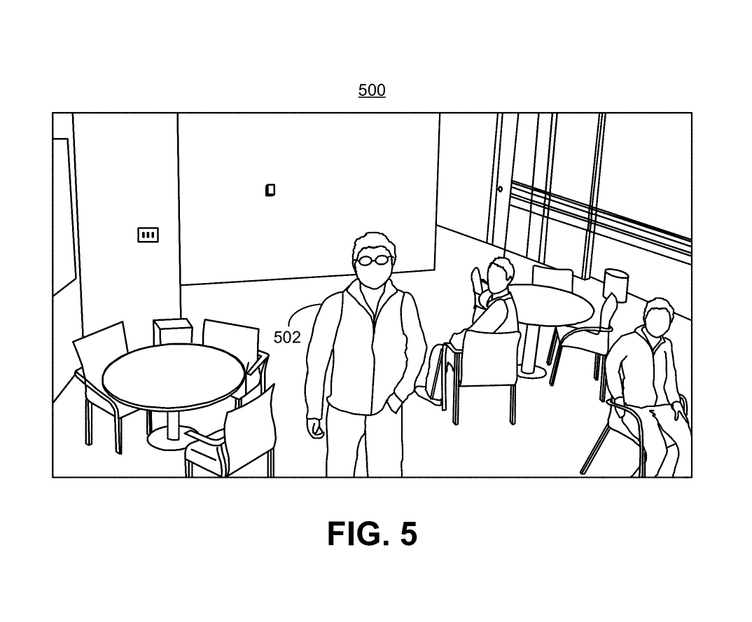

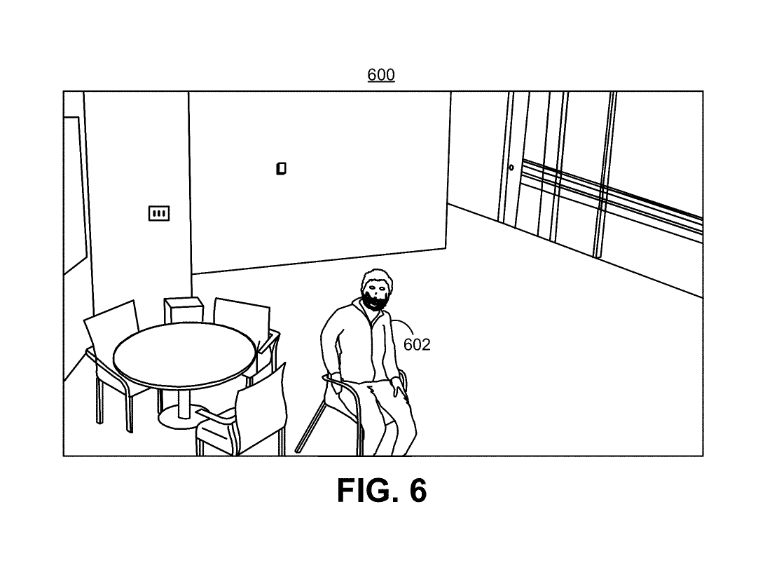

The false positive detection techniques described herein can apply based on any type of characteristic feature that is associated with faces and that can cause the face recognition process to falsely identify a face in a captured image as a face in an enrolled database. Examples of characteristic features that will be described herein for illustrative purposes include eyeglasses and beards. FIG. 5 is an example of a video frame showing a person 502 within a scene. As shown, the person 502 is wearing eyeglasses. As described above, eyeglasses have strong edge features, which can lead to a false positive detection of the face of the person 502 with an enrolled person's face, even when the person 502 is not actually the enrolled person. FIG. 6 is an example of a video frame showing a person 602 within a scene. The person 602 has a beard, which can include strong edge features that can cause a false positive detection to occur. While examples are described herein using eyeglasses and beards as illustrative examples of characteristic features, one of ordinary skill will appreciate that the same techniques can apply to reject faces (and other objects) that are recognized due to other characteristic features associated with the faces.

The information in the pre-defined database can be generated by using training images containing faces with different versions of at least one characteristic feature. As noted above, data clustering can be used to generate the information in the pre-defined database based on the training images. Eyeglasses will be used as an illustrative example of a characteristic feature. For example, given a set of training images, the features of the faces in the images are extracted. The local features of the faces can be extracted, instead of holistic features. For example, each face can be divided into a number of patches, and a local feature vector can be extracted for each patch. In some cases, a feature vector can be generated for each face by concatenating the local feature vectors of the different face patches. In some cases, because local features of the face are extracted, the local facial features can be divided into several parts or feature groups. In one illustrative example, the features in the upper half of a face can be grouped into a first group of features, and the features in the lower half of the face can be grouped into a second group of features. In such an example, some of the features can be grouped into both the first feature group (the upper features) and the second feature group (the lower features). In such cases, a feature vector can be generated for the upper feature group and another feature vector can be generated for the lower feature group by concatenating the local feature vectors of the face patches in each group. In some cases, the feature vectors grouped in the upper feature group can be used for recognizing faces with eyeglasses and the feature vectors grouped in the lower feature group can be used for recognizing faces with beards. In another example, an upper face area, a lower face area, and a center face area can be defined as three different feature groups.

For each feature group, a data clustering method is applied to cluster the features from the different faces of the training images into K cluster groups. For example, 1000 feature vectors of the upper portion of 1000 different faces can be clustered into K cluster groups using the data clustering method. In this same example, 1000 feature vectors of the lower portion of 1000 different faces can also be clustered into K cluster groups. A representative feature vector can then be selected for each cluster group from the K cluster groups. For example, for each cluster, a feature vector from the feature vectors of the different faces that is closest to the center of the cluster will be selected as a representative feature vector.

There are many clustering methods that can be used for clustering. One illustrative example of a clustering method is a modified K-means algorithm that is used to cluster the features into K clusters. Traditional K-means clustering aims to partition N observations into K clusters, with each observation belonging to the cluster with the nearest mean to that observation, serving as a prototype of the cluster. A modified K-means can be used to select the representative feature vector for each cluster. Using the modified K-means, the representative feature vector is selected as the feature vector from the feature vectors of the cluster that has the closest distance to the mean or center of the feature vectors of the cluster. For example, the feature vector closest to the center of a cluster is selected as the representative feature vector for the cluster. The representative feature vector selected for each of the K clusters will thus be the feature vector from the cluster that is closest to the center of that cluster. In one example, the face recognition system 200 can select feature vectors of faces with different kinds of eyeglasses and feature vectors of faces with different kinds of beards. The resulting representative feature vectors can be stored in the pre-defined database and are used to detect false positive faces (e.g., based on faces in input images having eyeglasses and/or beards).

As noted above, the feature extraction technique can extract local features of the faces contained in the training images, allowing the system to extract parts or patches of the face. For instance, a face in a training image can be segmented into a certain number of patches. In one illustrative example, the face can be segmented into 31 patches. Each patch covers part of the face. In some cases, one or more of the patches can be overlapping. The local features of each patch can be combined to form a feature vector for the face. For instance, as noted above, steerable filters (or other suitable feature extraction technique) can be used to determine a local feature map for each patch. In one illustrative example, one feature map may be generated representing an eye patch, another feature map might be generated representing part of the forehead, and so on until feature maps are generated for all of the patches (e.g., for all 31 patches using the previous illustrative example). The local feature maps of all patches of a face can be concatenated to form a feature vector for the face. For instance, using the illustrative example from above, feature extraction can be performed to generate 31 local feature maps for a face in a training image, and the 31 feature maps can be concatenated together to form a feature vector for that face.

The training images will have one or more characteristic features that are to be used for face trapping, and thus a feature vector generated for a face will include the features of the characteristic feature. For example, each feature vector of each face will include features related to glasses, beards, and/or other characteristic feature. The glasses, for example, will be part of the feature vector because the glasses are considered part of the face when feature extraction is performed, due to the glasses covering the eye locations.

In some cases, as previously noted, the face patches can be split into feature groups. For example, if there are 31 patches, for example, some patches can be defined to be in an upper feature group of the face and some patches can be defined to be in a lower feature group of the face. In one illustrative example, 15 of the feature maps (corresponding to 15 of the patches) can be in the upper feature group and the remaining 16 feature maps (corresponding to the remaining 16 patches) can be in the lower feature group. In some examples, some of the patches can be shared by the upper group and in the lower group, in which case the shared patches are included in both the upper group and in the lower group. In one illustrative example, one or more center patches in the center of a face can be included in the upper part and can also be included in the lower part. In some examples, the upper group can include one or more face patches (and corresponding feature maps) containing features of eyeglasses and the lower group can include one or more face patches (and corresponding feature maps) containing features of a beard.

Data clustering is then performed using the feature vectors extracted from the faces from the training images. For example, an input training set of training images can include images with different persons wearing different glasses and/or having different types of beards. In some cases, data clustering can be performed for each separate feature group (e.g., an upper and lower group). For instance, when the faces are divided into different feature groups (e.g., an upper and lower group), data clustering can be separately performed for each of the groups. In one illustrative example, each face can be divided into a number of patches (e.g., 31 patches), and the patches can be assigned to different parts of the face to form the feature groups (e.g., an upper group for the faces and a lower group for the faces). For each different feature group, a different K-means algorithm can be used to cluster the feature vectors from the different training images. In some cases, data clustering can be performed for the entire face when the faces are not separated into groups.

An output from the data clustering can include a representative feature vector for each cluster of the K clusters (e.g., for the face or for a feature group). The representative feature vector for a cluster can include the feature vector from the training images that is closest to the center of a particular cluster. For example, as noted above, one illustrative example of a data clustering method can include a modified K-means algorithm. The modified K-means is different from a traditional K-means algorithm, in that K-means uses a mean or the center as the representative feature. Instead of directly using the mean, the modified K-means selects the feature vector (extracted from a face) that is closest to the mean or center to represent the face. For example, the resulting representative feature vector is the feature vector from the feature vectors extracted from the training images that is closest to the center of the cluster, rather than the average of the features.

The modified K-means can be used to partition N observations into K clusters using the iterative refinement technique of the standard K-means algorithm. For example, an assignment step and an update step can be iteratively performed until the cluster assignments of the N observations no longer change. Each of the N observations can be assigned to the nearest cluster by distance. For instance, the assignment step can assign each observation to the cluster with the mean that is the least squared Euclidean distance to the observation. The update step can calculate the new means to be the centroids of the observations in the new clusters. The K-means algorithm can be considered to have converged when the assignments no longer change. The N observations represent the N feature vectors extracted from the training images of the input training set. For example, the training set can include 1,000 images with 1,000 faces, in which case 1,000 feature vectors can be extracted (one feature vector representing the features of each face). In such an example, N=1000. In another example when the faces are divided into separate groups (e.g., an upper and lower group), 1,000 feature vectors can be extracted for the upper group and 1,000 feature vectors can be extracted for the lower group. In such an example, N=1000 for the upper feature group and N=1000 for the lower feature group.

The term K refers to the number of clusters, representing the number of different shapes that are to be classified. For example, the 1,000 feature vectors from the training images can be grouped into 10 different clusters (K=10). Each of the 10 clusters can represent a different characteristic feature, a different type of a characteristic feature (e.g., different types of glasses, different types of facial hair, or the like), and/or different combinations of characteristic features (e.g., glasses only, men with glasses, women with glasses, men with glasses and beards, among others). The output is 10 representative feature vectors, with one representative feature vector being determined for each cluster. For example, for a first cluster of the 10 clusters, a feature vector from the input feature vectors from the first cluster that is closest to a mean of the first cluster is selected as the representative feature vector for the first cluster. A similar selection process is performed for the other 9 clusters. Using the example from above, given a training set of 1,000 images including persons all wearing some form of eyeglasses, each person's face can be divided into an upper portion (or upper feature group) with 16 patches and a lower portion (or lower feature group) with 15 patches (or, in some cases, the upper portion can include some of the same patches as the lower portion). In such an example, 1,000 feature vectors can be extracted for the upper portion of the faces, which can include the faces with the eyeglasses. 1,000 feature vectors can also be extracted for the lower portion of the faces, which can include the faces with the beards. The 1,000 feature vector for the upper portion of the face can then be clustered into 10 different clusters (K=10), and the 1,000 feature vector for the lower portion of the face can be clustered into 10 (K=10) different clusters. One feature vector can then be selected as the representative feature vector for each cluster, resulting in 10 representative feature vectors for the upper portion and 10 representative feature vectors for the lower portion.

The resulting representative feature vectors (e.g., 10 for the upper portion and 10 for the lower portion using the illustrative example from above) can then be used in the pre-defined database. For example, K representative feature vectors can be stored in the pre-defined database when the faces are not divided into different feature groups. In another example, K×2 representative feature vectors can be stored in the pre-defined database when the faces are divided into upper and lower feature groups. The pre-defined database is referred to below as the secondary database. The pre-defined database can be referred to as fr_glasses.db for cases in which the characteristic feature includes glasses. The representative feature vectors in the pre-defined database can then be used for comparison with feature vectors extracted from input images at run-time for face trapping. For example, K clusters for the lower facial portion can be used for trapping faces with beards and the K clusters for the upper facial portion can be used for trapping faces with glasses.

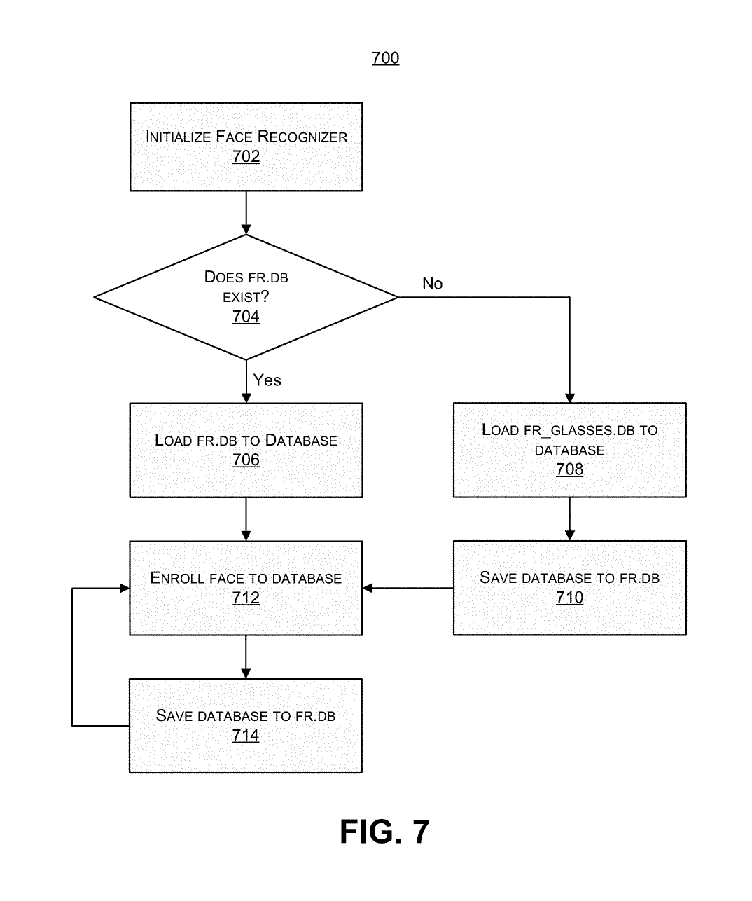

FIG. 7 is a flowchart illustrating an example of a process 700 for performing database initialization. The process 700 uses faces with glasses as an example of the characteristic features. However, the process 700 can apply to any other object and any other suitable characteristic features, as noted previously. The pre-calculated representative feature vectors of the clusters of faces with glasses can be stored in a secondary database called fr_glasses.db (also referred to herein as a pre-defined database). The primary database, called fr.db (also referred to herein as an enrolled database), is the database that contains enrolled faces. The enrolled faces can be faces of users registered with the system. Some of the enrolled faces may include glasses, and some of the enrolled faces may not include glasses. For example, an owner of a device having the face recognition system 200 may register the owner's face and other users' faces with the system 200, which may be stored in the primary database fr.db. The face recognition system 200 can process the faces and can extract feature vectors representing the faces. The feature vector of each face can be included in the database fr.db. In some cases, separate feature vectors can be extracted for different portions of an enrolled face. In one example, a first feature vector can be extracted for an upper portion of an enrolled face and a second feature vector can be extracted for a lower portion of an enrolled face, similar to that described above for the pre-defined database.

At block 702, the process 700 includes initializing a face recognizer. The face recognizer can include an end-to-end face recognition system, such as the face recognition system 200. At block 704, the process 704 includes determining whether the primary database fr.db exists yet in the face recognition system 200. When the primary database fr.db does not yet exist, it means there are no faces enrolled yet with the system 200. If, at block 704, it is determined that the primary database fr.db does not exist in the system 200, the process 700 (at block 708) initially loads the secondary database fr_glasses.db into the database in the memory of the device, and saves the database as fr.db at block 710. Otherwise, at block 706, the process 700 loads the database fr.db into the database in the memory of the device. After this initialization, all the feature vectors of the enrolled faces will be stored in the fr.db.

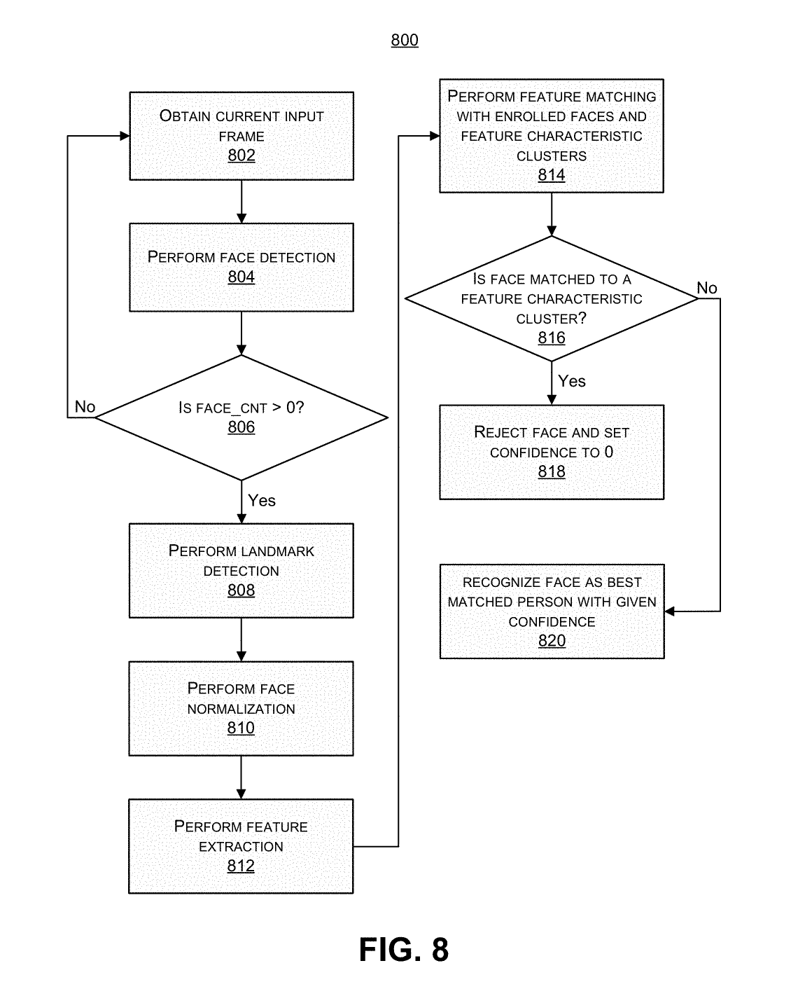

FIG. 8 is a flowchart illustrating an example of a process 800 for performing face recognition with false positive detection. The process 800 uses faces with glasses as an example of the characteristic features. However, the process 800 can apply to any other object and any other suitable characteristic features, as noted previously.

At block 802, the process 800 includes obtaining a current input frame. For instance, a device comprising the face recognition system 200 can include an image capture device. Illustrative examples of the device can include an IP camera, a mobile phone, a tablet, or other suitable device that can capture images. In some examples, the current input frame can be part of a video stream being captured by the device, and can include the frame currently being processed by the face recognition system 200. In some examples, the current input frame can include a still image captured by a camera of the device.

At block 804, the process 800 includes performing face detection for the current input frame. Face detection can be performed by the object detection engine 210 and can include the techniques described above with respect to FIG. 2. At block 806, it is determined whether any faces are detected in the current frame (denoted as face_cnt>0). If no faces are detected in the current input frame, the process 800 returns to block 802 to obtain a next input frame (which will become the current input frame).

If at least one face is detected in the current input frame, the process 800 proceeds to block 808 to perform further functions of the face recognition process 800. For example, landmark detection is performed at block 808, face normalization is performed at block 810, and feature extraction is performed at block 812. Landmark detection, face normalization, and feature extraction can be performed by the landmark detection engine 214, the object normalization engine 216, and the feature extraction engine 218, respectively, and can include the techniques described above with respect to FIG. 2.

At block 814, the process 800 includes performing feature matching with the enrolled faces and the feature characteristic clusters in the secondary database. For example, when a face is detected and fed to the face recognition process 800, its feature vector (e.g., as determined by the feature extraction engine 218) will be compared with all the feature vectors of the primary database (fr.db) and the representative feature vectors of the secondary database (fr_glasses.db). The feature matching can be performed using a distance metric to determine the closeness of the features being matched. Any suitable distance can be used, including Cosine distance, Euclidean distance, Manhattan distance, Mahalanobis distance, absolute difference, Hadamard product, polynomial maps, element-wise multiplication, or other suitable distance. For instance, the matching can be performed using a Cosine distance in a local search region of the feature map. In one illustrative example, a similarity between two faces can be computed as the sum of similarities of the two face patches. The sum of similarities can be based on a Sum of Absolute Differences (SAD) between an input face and each of the feature characteristic clusters, and also between the input face and each of the enrolled faces. The feature vector from the primary and secondary databases that is the closest feature vector to the probe feature vector (from the current input image) will be considered as the output of the face recognizer. In some cases, the best match is used as a confidence score (or matching score).

At block 816, the process 800 determines if the face from the input image is matched to a feature characteristic cluster (e.g., a glasses cluster) in the secondary database (fr_glasses.db). A feature characteristic cluster is represented by a representative feature vector from the secondary database. If the face of a person from the input image is determined to match a representative feature vector from the secondary database, the face will be detected as a false positive and rejected since it was matched to the representative faces from the secondary database instead of the enrolled faces. At block 818, the confidence score is set to 0 for the match. Since the feature vectors in the secondary database are the representative feature vectors of many training faces with different kinds of eyeglasses (or other characteristic features), there is a very high probability that a face with eyeglasses will be recognized as one of the representative vectors in the secondary database instead of an enrolled person with the eyeglasses. If the face is not matched to a feature characteristic cluster at step 816, the process 820 recognizes the face as a best matched person in the enrolled database (fr.db) with a given confidence score. The confidence score indicates how similar the input face is to the matched face. The confidence score of a face can be compared to a confidence threshold, and can be rejected if the confidence score is below the confidence threshold. At block 818, because the confidence score is set to 0, the face is rejected.

In some cases, a face in a captured image (at run-time) can include glasses (or other characteristic feature), but can be the face of an enrolled person. In such cases, the facial features of the person (other than the glasses or other characteristic feature) will cause the person's face to be matched to the enrolled feature vector of the person instead of one of the representative feature vectors in the pre-defined database, regardless of whether the enrolled face for the person had glasses. For example, the face in an input image may be matched to a face (a representative feature vector) from the pre-defined database and to a face from the enrolled database, with each match having a matching score indicating how confident the face recognition system 200 is that the match is accurate. However, the fact that all the facial features of the person (other than the characteristic feature) will be matched to the enrolled face will lead to a higher confidence score for the match from the enrolled database.

The false positive detection techniques have been experimented using a set of video clips. Half of the video clips contained people without eyeglasses at the different distances. The other half of the video clips contain the same people with different kinds of glasses, with the capturing condition being the same as the first half of the video clips. For face enrollment, one face image for each of a number of persons was enrolled, with half of the persons wearing different randomly selected glasses. The other half of the enrolled persons did not wear eyeglasses. Using a face recognition system, the face similarity was measured with matching scores and the range of the matching scores were between 0 and 1000. The higher the score is for a match between two faces, the more similar the two faces are.

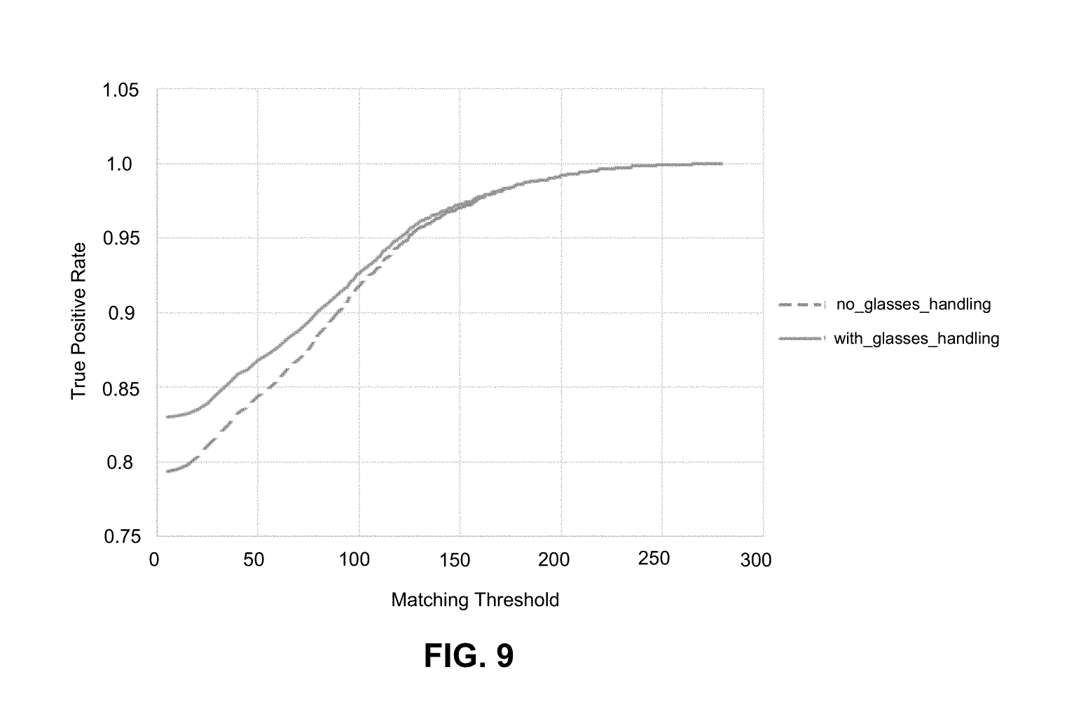

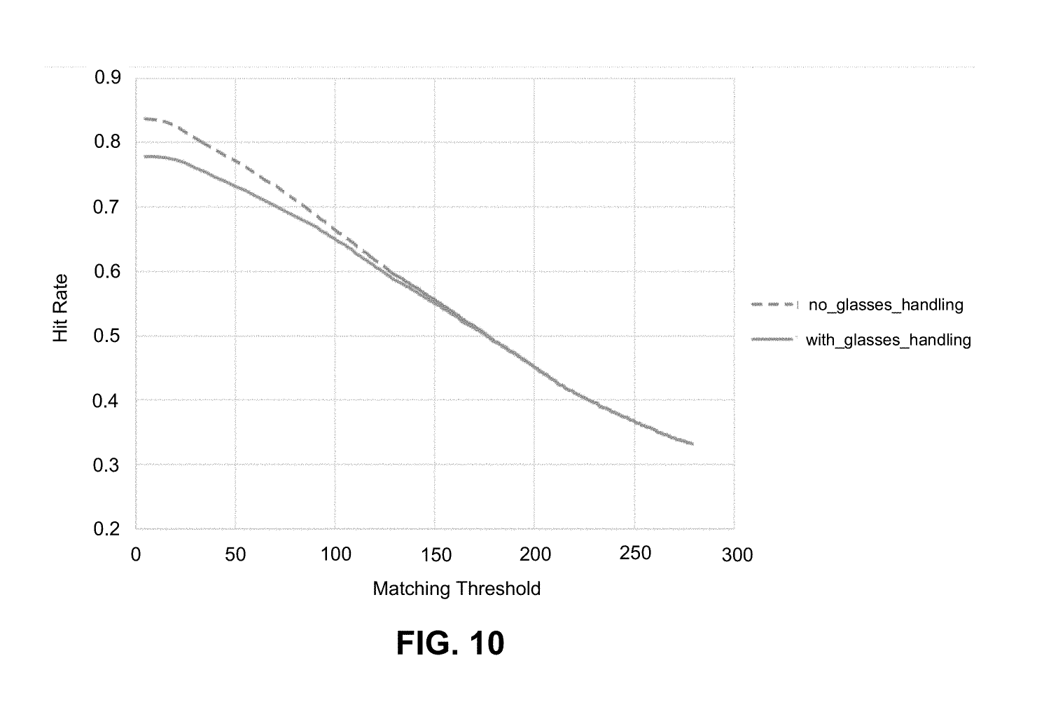

FIG. 9 and FIG. 10 are charts illustrative the test results from the above-described experiment. The chart shown in FIG. 9 illustrates the true positive rate (TP rate). The chart shown in FIG. 10 illustrates the hit rate. As shown, the confidence matching scores are from 5 to 280 (the x-axis). The chart in FIG. 9 shows that the glasses handling-based false positive detection method can improve true positive rate at the lower area of matching score (or confidence score) thresholds, and at the same time the hit rate shown in FIG. 10 slightly drops since some more faces are rejected by eyeglasses handling.

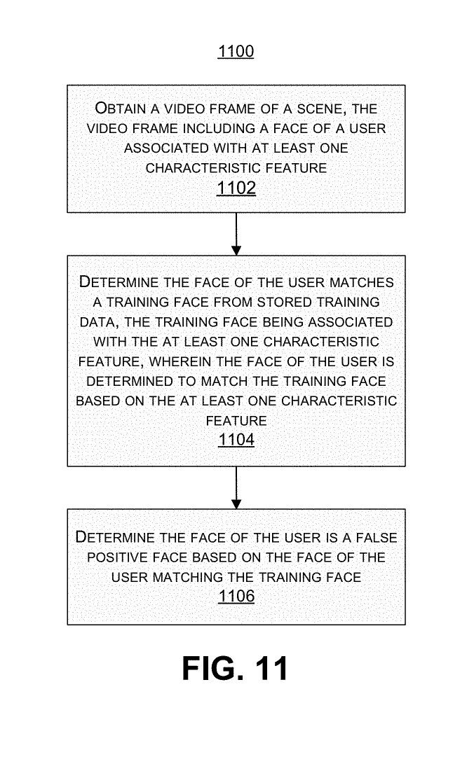

FIG. 11 is a flowchart illustrating an example of a process 1100 of detecting false positive faces in one or more video frames using the techniques described herein. At block 1102, the process 1100 includes obtaining a video frame of a scene. The video frame can includes the frame (e.g., a frame of a video sequence or an image) currently being processed by a face recognition system or other suitable system or device. The video frame includes a face of a user associated with at least one characteristic feature. In some examples, the at least one characteristic feature includes glasses. In some examples, the at least one characteristic feature includes facial hair. As described herein, one of ordinary skill will appreciate that the characteristic feature can include any other suitable characteristic feature that can cause a false positive recognition to occur.

At block 1104, the process 1100 includes determining the face of the user matches a representative face from stored representative data. The representative face is associated with the at least one characteristic feature. The face of the user is determined to match the representative face based, at least in part, on the at least one characteristic feature.

At block 1106, the process 1100 includes determining the face of the user is a false positive face based on the face of the user matching the representative face. For example, it can be determined that the face of the user is matched to the representative face only due to the characteristic feature, but that the user is not actually the person having the representative face. The object recognition process can reject the user's face as a false positive.

In some examples, the process 1100 includes accessing the representative data. The representative data includes information representing features of a plurality of representative faces associated with different versions of at least one characteristic feature. For example, the representative data can include feature vectors representing faces from a set of training images that include different types of eyeglasses, different types of facial hair, or other characteristic features. In examples in which the at least one characteristic feature includes glasses, the different versions of the at least one characteristic feature include different types of glasses. In examples in which the at least one characteristic feature includes facial hair (such as a beard), the different versions of the at least one characteristic feature include different types of facial hair (e.g., different types of beards, such as long, short, thick, thin, or the like). As noted above, the characteristic feature and associated versions can include any other suitable characteristic feature. In such examples, the process 1100 further includes accessing registration data. The registration data includes information representing features of a plurality of registered faces. In some cases, the registration data can be stored in an enrolled database (also referred to above as a primary database). In such examples, the process 1100 further includes comparing information representing features of the face of the user with the information representing the features of the plurality of representative faces and with the information representing the features of the plurality of registered faces. The face of the user is determined to match the representative face and determined be a false positive face (at block 1106) based on the comparison.

In some examples, comparing the information representing the features of the face of the user with the information representing the features of the plurality of registered faces is performed without using the at least one representative feature. For instance, the comparison of the face with the representative faces can be performed using the at least one representative feature, while the comparison of the face with the plurality of registered faces can be performed without using the at least one representative feature. In one illustrative example using glasses as a representative feature, the comparison of the information representing the features of the face with the information representing the features of the plurality of registered faces can be performed using all features except for the features corresponding to the glasses. In some examples, comparing the information representing the features of the face of the user with the information representing the features of the plurality of registered faces is performed using the at least one representative feature, in which case the comparison of the face against both the representative faces and the registered faces is performed using the at least one representative feature along with other features of the faces.

In some examples, determining the face of the user matches the representative face from the representative data includes comparing information representing features of the face of the user with information representing features of a plurality of representative faces from the representative data, and also comparing the information representing features of the face of the user with information representing features of a plurality of registered faces from registration data. The face from the representative data is determined to be a closest match with the face of the user based on the comparison. In some cases, the information representing features of the face of the user is determined by extracting features of the face from the video frame. For instance, the feature extraction engine 218 can extract features of the face from the video frame using the techniques described above with respect to FIG. 2. In some cases, the information representing the features of the plurality of faces from the representative data includes a plurality of representative feature vectors for the plurality of faces. For example, the representative feature vectors can be derived or determined using the techniques described above.

In some examples, the process 1100 includes generating the representative data by obtaining a set of representative images (referred to above as training images). Each representative image from the set of representative images includes a respective face from a plurality of faces. The plurality of faces in the representative images are associated with different versions of the at least one characteristic feature. For example, each face can have a different pair of glasses and/or a different type of beard. In such examples, generating the representative data further includes generating a plurality of feature vectors for the plurality of faces. For example, a feature vector can be determined for each face of the plurality of faces. Data clustering can then be performed to cluster the plurality of feature vectors and to determine a plurality of cluster groups. Generation of the feature vectors and the clustering can be performed using the previously described techniques. Generating the representative data further includes determining, for a cluster group from the plurality of cluster groups, a representative feature vector from the plurality of feature vectors. For example, a representative feature vector can be determined for each cluster group. The representative feature vector for a cluster group can be determined from among the feature vectors in the cluster group. For instance, the representative feature vector is the feature vector from the plurality of generated feature vectors that is closest to a mean of the cluster. Generating the representative data further includes adding the representative feature vectors to the representative data. The representative feature vector determined for the cluster group from the plurality of cluster groups represents a representative face from a plurality of representative faces in the representative data. For example, the representative feature vector represents the feature vectors of the faces that are part of the same cluster as the face from which the representative feature vector was extracted.

In some cases, the process 1100 includes extracting one or more local features of each face from the plurality of faces, and generating the plurality of feature vectors for the plurality of faces using the extracted one or more local features. For example, as described above, a face in an image can be segmented into a number of patches, and the local features of the patches can be combined to form a feature vector for the face.

In some examples, the process 1100 includes dividing the one or more local features into a plurality of feature groups. For example, as described above, the local features can be assigned to different feature groups, such as an upper feature group and a lower feature group. In some cases, local features can belong to multiple groups. In such examples, generating the plurality of feature vectors includes generating a feature vector for each feature group of the plurality of feature groups. In one illustrative example, an upper feature group and a lower feature group can be defined, in which case a first feature vector can be generated for the upper feature group and a second feature vector can be generated for the lower feature group.

In some examples, the processes 700, 800, and/or 1100 may be performed by a computing device or an apparatus. In one illustrative example, the processes 700, 800, and/or 1100 can be performed by the object recognition system 200 shown in FIG. 2. In some cases, the computing device or apparatus may include a processor, microprocessor, microcomputer, or other component of a device that is configured to carry out the steps of processes 700, 800, and/or 1100. In some examples, the computing device or apparatus may include a camera configured to capture video data (e.g., a video sequence) including video frames. For example, the computing device may include a camera device (e.g., an IP camera or other type of camera device) that may include a video codec. In some examples, a camera or other capture device that captures the video data is separate from the computing device, in which case the computing device receives the captured video data. The computing device may further include a network interface configured to communicate the video data. The network interface may be configured to communicate Internet Protocol (IP) based data.

Processes 700, 800, and/or 1100 are illustrated as logical flow diagrams, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes 700, 800, and/or 1100 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

The object recognition techniques discussed herein may be implemented using compressed video or using uncompressed video frames (before or after compression). An example video encoding and decoding system includes a source device that provides encoded video data to be decoded at a later time by a destination device. In particular, the source device provides the video data to destination device via a computer-readable medium. The source device and the destination device may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, the source device and the destination device may be equipped for wireless communication.

The destination device may receive the encoded video data to be decoded via the computer-readable medium. The computer-readable medium may comprise any type of medium or device capable of moving the encoded video data from source device to destination device. In one example, computer-readable medium may comprise a communication medium to enable source device to transmit encoded video data directly to destination device in real-time. The encoded video data may be modulated according to a communication standard, such as a wireless communication protocol, and transmitted to destination device. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device to destination device.

In some examples, encoded data may be output from output interface to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device. Destination device may access stored video data from the storage device via streaming or download. The file server may be any type of server capable of storing encoded video data and transmitting that encoded video data to the destination device. Example file servers include a web server (e.g., for a website), an FTP server, network attached storage (NAS) devices, or a local disk drive. Destination device may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system may be configured to support one-way or two-way video transmission to support applications such as video streaming, video playback, video broadcasting, and/or video telephony.

In one example the source device includes a video source, a video encoder, and a output interface. The destination device may include an input interface, a video decoder, and a display device. The video encoder of source device may be configured to apply the techniques disclosed herein. In other examples, a source device and a destination device may include other components or arrangements. For example, the source device may receive video data from an external video source, such as an external camera. Likewise, the destination device may interface with an external display device, rather than including an integrated display device.

The example system above merely one example. Techniques for processing video data in parallel may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device and destination device are merely examples of such coding devices in which source device generates coded video data for transmission to destination device. In some examples, the source and destination devices may operate in a substantially symmetrical manner such that each of the devices include video encoding and decoding components. Hence, example systems may support one-way or two-way video transmission between video devices, e.g., for video streaming, video playback, video broadcasting, or video telephony.

The video source may include a video capture device, such as a video camera, a video archive containing previously captured video, and/or a video feed interface to receive video from a video content provider. As a further alternative, the video source may generate computer graphics-based data as the source video, or a combination of live video, archived video, and computer-generated video. In some cases, if video source is a video camera, source device and destination device may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by the video encoder. The encoded video information may then be output by output interface onto the computer-readable medium.

As noted, the computer-readable medium may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from the source device and provide the encoded video data to the destination device, e.g., via network transmission. Similarly, a computing device of a medium production facility, such as a disc stamping facility, may receive encoded video data from the source device and produce a disc containing the encoded video data. Therefore, the computer-readable medium may be understood to include one or more computer-readable media of various forms, in various examples.

As noted above, one of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

In the foregoing description, aspects of the application are described with reference to specific embodiments thereof, but those skilled in the art will recognize that the invention is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

What is claimed is:

1. A method of detecting false positive faces in one or more video frames, the method comprising:
obtaining a video frame of a scene, the video frame including a face of a user associated with at least one characteristic feature;
determining the face of the user matches a representative face from stored representative data, the representative face being associated with the at least one characteristic feature, wherein the face of the user is determined to match the representative face based on the at least one characteristic feature; and
determining the face of the user is a false positive face based on the face of the user matching the representative face.

2. The method of claim 1, further comprising:
accessing the representative data, the representative data including information representing features of a plurality of representative faces associated with different versions of at least one characteristic feature;
accessing registration data, the registration data including information representing features of a plurality of registered faces; and
comparing information representing features of the face of the user with the information representing the features of the plurality of representative faces and with the information representing the features of the plurality of registered faces;
wherein the face of the user is determined to match the representative face and determined to be a false positive face based on the comparison.

3. The method of claim 2, wherein the information representing the features of the plurality of faces from the representative data includes a plurality of representative feature vectors for the plurality of faces.

4. The method of claim 2, wherein comparing the information representing the features of the face of the user with the information representing the features of the plurality of registered faces is performed without using the at least one representative feature.

5. The method of claim 1, wherein determining the face of the user matches the representative face from the representative data includes:
comparing information representing features of the face of the user with information representing features of a plurality of representative faces from the representative data and with information representing features of a plurality of registered faces from registration data; and
determining the face from the representative data is a closest match with the face of the user based on the comparison.

6. The method of claim 5, wherein the information representing features of the face of the user is determined by extracting features of the face from the video frame.

7. The method of claim 1, wherein the at least one characteristic feature includes glasses, and wherein different versions of the at least one characteristic feature includes different types of glasses.

8. The method of claim 1, wherein the at least one characteristic feature includes facial hair, and wherein different versions of the at least one characteristic feature includes different types of facial hair.

9. The method of claim 1, further comprising generating the representative data, wherein generating the representative data comprises:
obtaining a set of representative images, each representative image including a face from a plurality of faces associated with different versions of the at least one characteristic feature;
generating a plurality of feature vectors for the plurality of faces;
clustering the plurality of feature vectors using data clustering to determine a plurality of cluster groups;
determining, for a cluster group from the plurality of cluster groups, a representative feature vector from the plurality of feature vectors, the representative feature vector being closest to a mean of the cluster; and
adding the representative feature vector to the representative data, the representative feature vector representing a representative face from a plurality of representative faces in the representative data.

10. The method of claim 9, further comprising:
extracting one or more local features of each face from the plurality of faces; and
generating the plurality of feature vectors for the plurality of faces using the extracted one or more local features.

11. The method of claim 10, further comprising:
dividing the one or more local features into a plurality of feature groups; and
wherein generating the plurality of feature vectors includes generating a feature vector for each feature group of the plurality of feature groups.

12. An apparatus for detecting false positive faces in one or more video frames, comprising:
a memory configured to store video data associated with the video frames; and
a processor configured to:
obtain a video frame of a scene, the video frame including a face of a user associated with at least one characteristic feature;
determine the face of the user matches a representative face from stored representative data, the representative face being associated with the at least one characteristic feature, wherein the face of the user is determined to match the representative face based on the at least one characteristic feature; and
determine the face of the user is a false positive face based on the face of the user matching the representative face.

13. The apparatus of claim 12, wherein the processor is configured to:
access the representative data, the representative data including information representing features of a plurality of representative faces associated with different versions of at least one characteristic feature;
access registration data, the registration data including information representing features of a plurality of registered faces; and
compare information representing features of the face of the user with the information representing the features of the plurality of representative faces and with the information representing the features of the plurality of registered faces;
wherein the face of the user is determined to match the representative face and determined be a false positive face based on the comparison.

14. The apparatus of claim 13, wherein the information representing the features of the plurality of faces from the representative data includes a plurality of representative feature vectors for the plurality of faces.

15. The apparatus of claim 13, wherein comparing the information representing the features of the face of the user with the information representing the features of the plurality of registered faces is performed without using the at least one representative feature.

16. The apparatus of claim 12, wherein determining the face of the user matches the representative face from the representative data includes:
comparing information representing features of the face of the user with information representing features of a plurality of representative faces from the representative data and with information representing features of a plurality of registered faces from registration data; and
determining the face from the representative data is a closest match with the face of the user based on the comparison.

17. The apparatus of claim 16, wherein the information representing features of the face of the user is determined by extracting features of the face from the video frame.

18. The apparatus of claim 12, wherein the at least one characteristic feature includes glasses, and wherein different versions of the at least one characteristic feature includes different types of glasses.

19. The apparatus of claim 12, wherein the at least one characteristic feature includes facial hair, and wherein different versions of the at least one characteristic feature includes different types of facial hair.

20. The apparatus of claim 12, wherein the processor is configured to generate the representative data, wherein generating the representative data comprises:
obtaining a set of representative images, each representative image including a face from a plurality of faces associated with different versions of the at least one characteristic feature;
generating a plurality of feature vectors for the plurality of faces;
clustering the plurality of feature vectors using data clustering to determine a plurality of cluster groups;
determining, for a cluster group from the plurality of cluster groups, a representative feature vector from the plurality of feature vectors, the representative feature vector being closest to a mean of the cluster; and
adding the representative feature vector to the representative data, the representative feature vector representing a representative face from a plurality of representative faces in the representative data.

21. The apparatus of claim 20, wherein the processor is configured to:
extract one or more local features of each face from the plurality of faces; and
generate the plurality of feature vectors for the plurality of faces using the extracted one or more local features.

22. The apparatus of claim 21, wherein the processor is configured to:
divide the one or more local features into a plurality of feature groups; and
wherein generating the plurality of feature vectors includes generating a feature vector for each feature group of the plurality of feature groups.

23. The apparatus of claim 12, wherein the apparatus comprises a mobile device.

24. The apparatus of claim 23, further comprising one or more of:
a camera for capturing the one or more video frames; and
a display for displaying the one or more video frames.

25. A non-transitory computer-readable medium having stored thereon instructions that, when executed by one or more processors, cause the one or more processor to:
obtain a video frame of a scene, the video frame including a face of a user associated with at least one characteristic feature;
determine the face of the user matches a representative face from stored representative data, the representative face being associated with the at least one characteristic feature, wherein the face of the user is determined to match the representative face based on the at least one characteristic feature; and
determine the face of the user is a false positive face based on the face of the user matching the representative face.

26. The non-transitory computer-readable medium of claim 25, further comprising instructions that, when executed by one or more processors, cause the one or more processor to:
access the representative data, the representative data including information representing features of a plurality of representative faces associated with different versions of at least one characteristic feature;
access registration data, the registration data including information representing features of a plurality of registered faces; and
compare information representing features of the face of the user with the information representing the features of the plurality of representative faces and with the information representing the features of the plurality of registered faces;
wherein the face of the user is determined to match the representative face and determined be a false positive face based on the comparison.

27. The non-transitory computer-readable medium of claim 25, wherein determining the face of the user matches the representative face from the representative data includes:
comparing information representing features of the face of the user with information representing features of a plurality of representative faces from the representative data and with information representing features of a plurality of registered faces from registration data; and
determining the face from the representative data is a closest match with the face of the user based on the comparison.

28. The non-transitory computer-readable medium of claim 25, wherein the at least one characteristic feature includes glasses, and wherein different versions of the at least one characteristic feature includes different types of glasses.

29. The non-transitory computer-readable medium of claim 25, wherein the at least one characteristic feature includes facial hair, and wherein different versions of the at least one characteristic feature includes different types of facial hair.

30. The non-transitory computer-readable medium of claim 25, further comprising instructions that, when executed by one or more processors, cause the one or more processor to generate the representative data, wherein generating the representative data comprises:
obtaining a set of representative images, each representative image including a face from a plurality of faces associated with different versions of the at least one characteristic feature;
generating a plurality of feature vectors for the plurality of faces;
clustering the plurality of feature vectors using data clustering to determine a plurality of cluster groups;
determining, for a cluster group from the plurality of cluster groups, a representative feature vector from the plurality of feature vectors, the representative feature vector being closest to a mean of the cluster; and
adding the representative feature vector to the representative data, the representative feature vector representing a representative face from a plurality of representative faces in the representative data.
